(19) United States
(12) Patent Application Publication
(10) Pub. No.: US 2005/0117145 A1
(43) Pub. Date: Jun. 2, 2005

(54) Detection of imperfections in precious stones

(76) Inventors: Joshua Altman, Tel-Aviv (IL); Moshe Tshuva, Tel-Aviv (IL); Zeev Leshem, Maccabim (IL); Nadav Haas, Merkaz-Shapira (IL); Avi Kerner, Hertzeliya (IL); Udi Lederer, Tel-Aviv (IL)

Correspondence Address: DANIEL J SWIRSKY, PO BOX 2345, BEIT SHEMESH, 99544, IL

(21) Appl. No.: 10/722,588

(22) Filed: Nov. 28, 2003

(51) Int. Cl. G01N 21/00

(52) U.S. Cl. 356/30

(57) ABSTRACT

A system for the inspection of a precious stone, including an energy transfer system for changing the temperature of the stone, at least one imaging device imaging the stone and outputting a thermal map of the stone, an image processing unit utilizing the thermal map to determine regions having changed emission in the thermal map, and an analyzing unit detecting at least one imperfection in the stone from the regions of changed emission.

### FIELD OF THE INVENTION

The present invention relates to the field of the determination of the quality of precious stones, and especially to the detection and mapping of internal imperfections or inclusions in diamonds.

### BACKGROUND OF THE INVENTION

Natural diamonds almost inevitably have imperfections and impurity content. The fewer the imperfections or impurity content, the higher the brilliance and transparency of the stone, and the higher its value. In the diamond industry, the value of a stone is determined by what is known as the four C's—Clarity, Color, Cut and Carat. Of these parameters, the clarity is possibly the most difficult to determine, as it requires an assessment of the appearance of the stone, both internal and external, which has, in the past, been essentially a subjective appraisal. This assessment is generally performed by visual inspection using a loupe of ×10 magnification, preferably corrected for chromatic and spherical aberrations to ensure optimum reliability and accuracy. One of the main factors in determining the clarity of the stone is the presence of internal defects known as inclusions. Such inclusions can be of bubbles or of solid material, and one of the most common of such solid inclusions is carbon in a non-diamond form. The latter results in small spots within the interior of the stone, of color which can range from almost colorless to black, and are known in the industry as piques.

The effect of an internal inclusion on the value of the stone is dependent on a number of factors, including the number, nature, size, color and location of the inclusion or inclusions within the stone. Thus, for instance, an inclusion near the center of the stone is much more serious than an inclusion near what will become the girdle of the stone, where its visual effect can generally be reduced by careful mounting technique. Similarly, darker inclusions are more serious than lighter colored ones. Because of the significant effect such inclusions have on the quality, and hence value of the stone, their detection and classification is of great importance. Furthermore, knowledge of the extent and location of inclusions in an uncut stone can help the diamontaire in the decision-making process of how and where to cut the rough stone in order to obtain the maximum value therefrom.

In addition to the detection of physical inclusions made up of foreign material or of regions of contamination in the diamond, it is also important to detect the presence of imperfections of the structure within the stone, resulting from internal structural flaws, such as cracks, cleavages, knots, small included crystals of different orientation to the rest of the stone, or other internal physical defects. Such imperfections are usually more difficult to detect than inclusions using the prior art visual inspection methods, because of their generally low contrast against the rest of the stone, and because of the difficulty in distinguishing them from surface damage on the raw stone. The above-described methods and their disadvantages also apply, to a greater or lesser extent, when applied to the inspection of other precious stones, besides diamonds.

The currently used subjective methods of visual detection are often unreliable and slow. There therefore exists an important need for a system and method which can detect the location, character and severity of inclusions and imperfections within precious stones, and especially diamonds, based on objective and repeatable measurement techniques, thereby overcoming some of the disadvantages of the present visual subjective methods.

### SUMMARY OF THE INVENTION

The present invention seeks to provide a new system and method for the detection of imperfections, and especially of inclusions in precious stones, and especially in diamonds, which is based on the computerized inspection and analysis of an optical image of the stone, preferably in the thermal infra-red region. The general term detection is understood to include not only the actual presence but also the location, the size or extent and the character of the imperfection, and the term is sometimes thus used and is thus claimed in this application. Being computerized, the system is thus able to provide an objective and repeatable measure of the severity, characteristics and location of the inclusions. The term characteristics is generally understood in this application to include at least one of the size, the type and the optical absorption properties of the imperfection.

According to a first preferred embodiment, the system operates by preferably raising the temperature of the stone above that of the ambient environment, and viewing the infra-red radiation emitted by the stone, preferably by means of an infra-red camera, though any other suitable imaging device may also be used. Inclusions are detected by the fact that they emit more radiation than the clear regions of the stone, and can thus be mapped on an infra-red image of the stone. The extent and severity of the inclusion is determined by the differential radiation pattern generated in the regions of the inclusions. Imperfections can often be detected by the scatter that they impart to the radiation emitted by the heated stone, though other optical mechanisms may also be operative to render such imperfections visible in the infra-red images.

Diamond is known to have good optical transmission, generally of over 70% through the visible and infra-red regions of the spectrum, with the exception of narrow and slight absorption bands in the region of from 5 to 7 microns, at least for type Ia diamonds, which are the most commonly found natural diamonds. The inclusions in the stone, on the other hand, have a higher absorptivity at the thermal IR wavelengths preferably used for the imaging of the stone in the present invention. Since the emissivity of each part of the stone generally has a one-to-one relationship to the absorptivity, the inclusions also therefore have a higher emissivity than the surrounding clear diamond. If the stone is thus heated to a temperature above ambient, the inclusions, having high emissivity, radiate significantly more than the clear diamond, having a very low emissivity, and thus the inclusions can be clearly distinguished in the IR image captured by the camera. This difference in emissivity is so pronounced that even small inclusions, or inclusions having a very slight color, emit many times more efficiently than the clear diamond around them, and are readily discerned. The thermal profile of the stone after heating, as observed on the output image captured by the camera, can thus be analyzed by suitable image processing procedures, to provide a map of the location and severity of the inclusion or inclusions in the stone.

The heating of the stone can preferably be performed by any suitable method, such as by radiation heating, in an oven, by forced convection heating, such as by a hot-air fan, or by conduction such as on a heated plate. The heating means should preferably be such that the stone is brought to a uniform temperature. In order to avoid the heating means from interfering with the IR image obtained, heating is generally ceased before the IR images are captured, and the stone is imaged while it is cooling down, or, if the stone is well insulated from its environment, in an almost steady state. Alternatively and preferably, the heating may be performed from one direction, and the imaging from another direction which does not look directly at the heating source, such as orthogonally to the direction of heating. Additionally, the heating may preferably be performed at a wavelength different from that at which the imaging is performed, such as by the use of filters in the imaging path or in the illuminating path. In such a situation, reflections and scattering of the incident heating radiation do not appreciably interfere with the imaging process, which can thus be continued while the stone is still being heated. Heating of the stone at ultra violet wavelengths is generally advantageous, since the stones, and especially diamond, absorb in that region appreciably more than in the visible or IR. In particular, all types of diamond absorb strongly below approximately 225-250 nm, depending on the type.

The use of a thermally protective enclosure around the stone may be of assistance in maintaining the temperature of the stone after the heating stage, and in protecting the stone from extraneous sources of radiation while being imaged. An even better signal-to-noise ratio is obtained if the heated stone is surrounded by a cooled enclosure, preferably open only in the direction from where the stone is viewed by the camera. Such cooling is preferably performed by means of thermoelectric cooling elements attached to the enclosure walls. Temperatures somewhat below that of room temperature are readily and simply obtained by this means, and result in a significant reduction in the effects of extraneous IR radiation on the captured IR images of the stone.

In order to determine the location of the imperfections or inclusions in three dimensions, it is necessary to image the stone from at least two, preferably orthogonal, directions. This can preferably be accomplished by means of a rotating turntable on which the stone is mounted, or by means of two cameras accordingly arranged, or by means of an optical arrangement, preferably of reflectors and a shutter or switching mirror which enables a single camera to alternately image the stone from either selected orthogonal direction.

According to another preferred embodiment of the present invention, the stone is heated, preferably by means of a radiation source, such that the inclusions, with their higher absorptivity, absorb more energy from the beam than the clear regions of the diamond, with their low absorptivity. The temperature of the inclusions thus rises above that of the surrounding diamond. The difference in absorptivity is so pronounced that even small inclusions, or inclusions having a very slight color, absorb many times more than the clear diamond surrounding the inclusions, and thus undergo a significant temperature rise over their immediate clear environment. This temperature differential in the stone, known in the IR imaging field as the “thermal signature” of the stone, is thus observed in the IR image captured by the camera.

Physically, this phenomenon is related to that described in the first embodiment above, each being described according to its own physical model, since the absorptivity and emissivity of the inclusions have a strong correspondence close correlation to each other. However, this embodiment of the present invention is likely to provide more pronounced images of the inclusions than those of the first embodiment, since in this second embodiment, two mechanisms are operative in generating the images of the inclusions. In the first place, the higher absorption of the inclusions and their ensuing higher temperature, contributes to imaging with good contrast against the rest of the stone. Secondly, their increased emissivity over the rest of the stone compounds the good contrast imaging effect of the increased temperature, resulting in an even better image contrast for the inclusions.

However, diamond has another unusual property which needs to be taken into account in the construction and operation of this embodiment of the system of the present invention, and specifically with respect to the dynamics of the measurement. Diamond has a very high thermal conductivity, possibly the highest in any natural material known to man. At room temperature, its thermal conductivity is more than five times higher than that of copper. As a result of this property, it is difficult to maintain a significant temperature gradient within the diamond. This difficulty is further compounded by the comparatively low specific heat of diamond, which property assists the high thermal conductivity in the transient heat diffusion in the diamond. This has a number of related consequences on the implementation of this embodiment of the present invention.

In the first place, in order to achieve the largest transient effect, it is advantageous that the input radiation be as high as possible, to obtain as large as possible a differential local temperature at the inclusions as soon as possible, before the high conductivity of the diamond “smears out” the local temperature rise at the inclusions. It may thus be preferable to use a large pulse of input radiation from a pulsed source such as a flash-tube or a pulsed laser, rather than continuous heating. Secondly, the heating effect on the inclusion is very localized, since the surrounding diamond conducts the heat generated at the inclusions away from the site very efficiently. This has a positive effect in that the position of the inclusion can be determined accurately because of the very localized temperature differential. However, one obstacle to the effective use of this embodiment is that the transient solutions of the differential equations of heat conduction from a hot spot in a diamond, when the source of heating is removed, show that the temperature differential decays very rapidly, and the diamond achieves a uniform temperature within a short time. This means that if the diamond is irradiated to raise its temperature, and then thermally imaged after the radiation has been terminated, the imaging must be performed rapidly after the cessation of the heating, to avoid the diamond from attaining thermal equilibrium and smearing out any temperature differential.

This effect has ramifications on the dynamics of the method whereby the imaging is performed, in comparison with that of the first described embodiment hereinabove. According to this preferred embodiment, the stone is preferably irradiated by an infra-red source, the source is cut off, and two preferably orthogonal images of the heated stone are taken in order to obtain three-dimensional information about the location of the inclusion or inclusions. The two images should be captured as soon as possible after terminating the radiation heating, and as simultaneously as possible. Simultaneous or close-to-simultaneous imaging is important because of the rapid decay of the temperature gradient generated at the inclusions. Such imaging can preferably be performed by one of the methods mentioned hereinabove using two cameras or an optical arrangement with one camera. Alternatively and preferably, this embodiment of the present invention can be operated using continuous heating and concurrent imaging, provided that the above-mentioned precautions are taken to shield the imaging camera from direct radiation, but such a steady state heating regime is likely to give a smaller temperature gradient at the inclusion than that obtained by transient heating or interrupted heating.

Though the heating of the stone, according to this preferred embodiment of the present invention, may be performed by an infra-red, a visible or an ultra-violet source, as expounded hereinabove, there may be specific advantages in using a visible source, since in the visible region, the differential absorption between the inclusions and the remainder of the diamond is greater than in the IR or in the UV. In the IR even the inclusions can be fairly transparent across much of the wavelength range, like the rest of the diamond though not to the same extent, and in the UV, both inclusions and diamond are fairly opaque. Consequently, use of a visible source raises the temperature difference of the inclusions over their background more quickly than an IR or UV source, thus providing better contrast according to this second embodiment.

According to the first embodiment mentioned above, where the stone is heated and then allowed to cool slowly while being imaged, or even imaged while still being heated, the dynamics of the imaging are less important, and the second orthogonal image of the stone required for obtaining the three-dimensional location of the inclusions or imperfections, can preferably be captured by the same camera, after rotating the stone, preferably through 90 degrees, such as on a turntable.

The IR imaging of the heated stone, at least according to the first of the above-described preferred embodiments, where imaging conditions are quasi-steady state, can be performed by one of two preferred methods. According to the first method, the imaging is performed at a fixed wavelength, and the temperature of the stone is slowly changed, preferably and conveniently during the cooling process. Images are taken repeatedly, the contrast of the inclusions against the rest of the stone varying according to the specific temperature of the stone. Comparison of the image strengths of these inclusions with information relating to the emissive properties of the inclusions as a function of temperature, previously stored in a databank, thus enables the nature and the position of the inclusions to be uniquely identified. According to the second method, the stone is kept at a constant temperature, and is imaged at a number of different wavelengths, or over different wavelength bands, whereby the contrast of the inclusions varies according to the imaging wavelength. Again, comparison of the wavelength behavior with a predetermined database of inclusion intensity information relating to the emissive properties of the inclusions as a function of wavelength, enables the nature and position of the inclusions to be uniquely detected and mapped.

According to a further preferred embodiment of the present invention, the imperfection or inclusion detection system operates by inducing a resonance into the stone by radiating it with an energy field having a frequency characteristic of the inclusions, but not of the surrounding clean diamonds. The energy field can be an electromagnetic field, such as a high frequency or RF field, or a phonon field, such as an ultrasonic field, or an optical beam tuned to be at a preselected wavelength, characteristic of the absorption spectrum of the inclusions, or of a specific part of their absorption spectrum. The inclusions selectively absorb energy from the field, and undergo a rise in temperature above that of the surrounding clean diamond. This rise in temperature is then detected preferably using an IR camera system, by one of the methods of detection described hereinabove in relation to the previous embodiments of this invention.

Though the above embodiments of the present invention have been largely described for use with diamonds, it is to be understood that the invention can also be used for the detection of inclusions and imperfections in other precious stones, and use of the term diamond throughout this application and as claimed, is understood to include other precious stones also, except in the few cases where it is clear that the reference is specifically to diamonds and their properties. Generally, however, use of such methods on other precious stones results in reduced image contrast, since the differential emissivity of the inclusions in other stones may not be as great as that in diamonds, because of the low absorptivity of diamond. Furthermore, though the above embodiments of the present invention have been variously described for use in the detection of imperfections, inclusions, and sometimes for either, it is to be understood that the term imperfections is taken in this application to mean a generic term for all such flaws in a stone, and is also so claimed, except in the specific cases where it is clear to one of the art that the embodiment would only operate satisfactorily on inclusions.

Furthermore, even though the various above embodiments of the present invention have been described using the heating of the stone under inspection, and the recording of infra-red images with temperatures above that of the environment, heating being a simple method of changing the temperature of the stone from ambient, it is to be understood that the invention can be equally executed if the stone is cooled below the temperature of the environment, and the different emissions or different temperatures of various regions of the stone thus recorded at temperatures below ambient. It is thus to be understood that wherever reference is made in this application to the heating of the stone to obtain a differential thermal image, this is not meant to be a limiting feature of the invention, and cooling of the stone to obtain a differential thermal image is also meant to be included and understood thereby. The exception to this is with respect to features of the application which may be only applicable to heating, such as for instance, in the descriptions of the preferred methods of achieving the temperature difference.

There is thus provided in accordance with a preferred embodiment of the present invention, a a system for the inspection of a precious stone, comprising an energy transfer system for changing the temperature of the stone, at least one imaging device imaging the stone and outputting a thermal map of the stone, an image processing unit utilizing the thermal map to determine regions having changed emission in the thermal map, and an analyzing unit detecting at least one imperfection in the stone from the regions of changed emission. The above-mentioned detecting can comprise determining at least one of the location, character and size of the at least one imperfection.

In accordance with other preferred embodiments of the present invention, in the above-mentioned system, the energy transfer system may comprise either an energy source such that the changing the temperature of the stone comprises raising the temperature of the stone above that of its environment, or an energy sink such that the changing the temperature of the stone comprises lowering the temperature of the stone below that of its environment.

Furthermore, in any of the above-mentioned embodiments, the at least one imaging device preferably images the stone in the infra red region. Also, the at least one imaging device may be a camera. Additionally and preferably, the regions of changed emission may result from a change in temperature at the location from the temperature in the remainder of the stone.

In various of the above-mentioned embodiments, the characteristics of the at least one imperfection in the stone are determined from the level of the changed emission, or from the level of the changed temperature, depending on the particular embodiment.

In accordance with still another preferred embodiment of the present invention, in any of the above-described systems, the at least one imaging device may be two imaging devices, such that the location of the at least one imperfection in the stone is determined in three dimensions. Alternatively and preferably, the stone may be angularly aligned relative to a single imaging device for imaging in at least two directions, such that the location of the at least one imperfection in the stone is determined in three dimensions. This may preferably be accomplished by means of a turntable on which the stone is mounted.

In those embodiments involving raising the temperature of the stone above that of its environment, the energy source may preferably be at least one of a radiation source, a hot air source, and a conduction source. The radiation source preferably emits at least one of infra red, visible or ultra violet energy. The conduction source may preferably be a hot plate. In those embodiments involving lowering the temperature of the stone below that of its environment, the energy sink may preferably be a thermo-electric cooling device.

According to still other preferred embodiments of the present invention, the above-described systems may also comprise a filter disposed between the source and the stone, such that the stone is irradiated with energy having a more limited wavelength bandwidth than the imaging bandwidth. Alternatively and preferably, the filter may be disposed between the stone and the imaging device, such that the stone is imaged at a wavelength bandwidth more limited than that of the radiation. In either of these two embodiments, the filter may be operative to reduce the effect of reflections or scattering of the energy from the radiation source on the images of the stone.

In accordance with a further preferred embodiment of the present invention, any of the above-described systems may preferably also comprise at least a pair of polarizing elements, at least one element being located between the energy source and the stone, and at least another element being located between the stone and the imaging device.

Furthermore, in any of the above-described systems, the stone may preferably be a diamond. Additionally, the imperfection may preferably be an inclusion or an internal structural flaw.

According to still further preferred embodiments of the present invention, in any of the above-described systems, the imaging device may generate successive images of the stone at different temperatures and at a fixed wavelength, and the system then determine the characteristics of a detected imperfection by comparison with predetermined information relating to the emissive properties of imperfections as a function of temperature. Alternatively and preferably, the imaging device may generate successive images of the stone at different wavelengths and at a fixed temperature, and the system determine the characteristics of a detected imperfection by comparison with predetermined information relating to the emissive properties of imperfections as a function of wavelength.

There is also provided in accordance with yet another preferred embodiment of the present invention, a method for the inspection of a precious stone, comprising the steps of changing the temperature of the stone by means of an energy transfer system, imaging the stone by means of at least one imaging device, outputting a thermal map of the stone from the at least one imaging device, image processing the thermal map to determine regions of changed emission in the thermal map, and analyzing the regions of changed emission for detecting at least one imperfection in the stone. The above-mentioned detecting can comprise determining at least one of the location, character and size of the at least one imperfection.

In accordance with other preferred embodiments of the present invention, in the above-mentioned method, the energy transfer system may comprise either an energy source such that the changing the temperature of the stone comprises raising the temperature of the stone above that of its environment, or an energy sink such that the changing the temperature of the stone comprises lowering the temperature of the stone below that of its environment.

Furthermore, in any of the above-mentioned embodiments, the at least one imaging device preferably images the stone in the infra red region. Also, the at least one imaging device may be a camera. Additionally and preferably, the regions of changed emission may result from a change in temperature at the location from the temperature in the remainder of the stone.

In those embodiments of the above-described method involving raising the temperature of the stone above that of its environment, the imaging step may preferably be performed after terminating the step of raising the temperature of the stone above that of its environment by means of the energy source. The step of terminating the raising the temperature of the stone may preferably be performed either by means of a shutter, or by transferring energy to the stone by means of at least one pulse of energy.

Alternatively and preferably, the above-mentioned imaging step is performed while the step of changing the temperature of the stone by means of an energy transfer system is continued.

In accordance with still another preferred embodiment of the present invention, in any of the above-described methods, the at least one imaging device may be two imaging devices, such that the location of the at least one imperfection in the stone is determined in three dimensions. Alternatively and preferably, the stone may be angularly aligned relative to a single imaging device for imaging in at least two directions, such that the location of the at least one imperfection in the stone is determined in three dimensions. This step of angularly aligning may preferably comprises the steps of providing a turntable for mounting the stone thereupon, and rotating the turntable with the stone mounted thereon to image the stone in at least two directions.

In those embodiments of the above-described methods, involving raising the temperature of the stone above that of its environment, the energy source may preferably be at least one of a radiation source, a hot air source, and a conduction source. The radiation source preferably emits at least one of infra red, visible or ultra violet energy. The conduction source may preferably be a hot plate. In those embodiments involving lowering the temperature of the stone below that of its environment, the energy sink may preferably be a thermo-electric cooling device.

According to still other preferred embodiments of the present invention, the above-described methods may also comprise the step of disposing a filter between the source and the stone, such that the stone is irradiated with energy having a more limited wavelength bandwidth than the imaging bandwidth. Alternatively and preferably, the filter may be disposed between the stone and the imaging device, such that the stone is imaged at a wavelength bandwidth more limited than that of the radiation. In either of these two embodiments, the filter may be operative to reduce the effect of reflections or scattering of the energy from the radiation source on the images of the stone.

Furthermore, in any of the above-described methods, the stone may preferably be a diamond. Additionally, the imperfection may preferably be an inclusion or an internal structural flaw.

There is even further provided in accordance with another preferred embodiment of the present invention, a computerized optical system for the analysis of precious stones, comprising a stone mapping module inputting information to an output shape allocator, the stone mapping module taking its inputs from a three dimensional spatial model of the stone, an input module defining a desired shape of at least one cut to be obtained from the precious stone, and output information from a computerized imperfection detection unit.

In this computerized optical system for the analysis of precious stones, the three dimensional spatial model of the stone preferably comprises at least one of a set of co-ordinates defining the envelope of the stone, a set of three-dimensional polygonic shapes, and a set of shapes defining planes in the stone, and their vectorial directions relative to a known origin. Furthermore, the three dimensional spatial model of the stone is preferably obtained from at least one of a stone dimension measuring unit, a stone shape measuring unit, a hole data input unit, and a groove data input unit. The computerized imperfection detection unit also preferably provides outline data of the stone for the three dimensional spatial model of the stone.

In any of the above-described computerized optical systems for the analysis of precious stones, the computerized imperfection detection unit is preferably a thermal imaging imperfection detection system.

### BRIEF DESCRIPTION OF THE DRAWINGS

The present invention will be understood and appreciated more fully from the following detailed description, taken in conjunction with the drawings in which:

FIG. 1 is a schematic illustration of a system for the detection and mapping of inclusions in a diamond, constructed and operative according to a first preferred embodiment of the present invention;

FIG. 2 is a schematic illustration of a further preferred embodiment of a system for the detection and mapping of inclusions in a diamond, similar to that shown in FIG. 1 but using a hot plate to heat the diamond;

FIG. 3 is a schematic illustration of a further preferred embodiment of a system for the detection and mapping of inclusions in a diamond, similar to that shown in FIG. 1 but in which use is made of a transient measurement technique;

FIG. 4 is a schematic visualization of a thermal image obtained using a system according to the present invention, showing a diamond being imaged during heating, and illustrating the presence of an inclusion in the diamond;

FIG. 5 is a schematic illustration of a further preferred embodiment of a system for the detection and mapping of inclusions in a diamond, similar to that shown in FIG. 1 but in which use is made of a source of energy to resonantly excite energy levels of the inclusions in the diamond; and

FIG. 6 is a schematic block diagram of a total solution, rough diamond computerized analyzing system, constructed and operative according to a further preferred embodiment of the present invention.

### DETAILED DESCRIPTION OF PREFERRED EMBODIMENTS

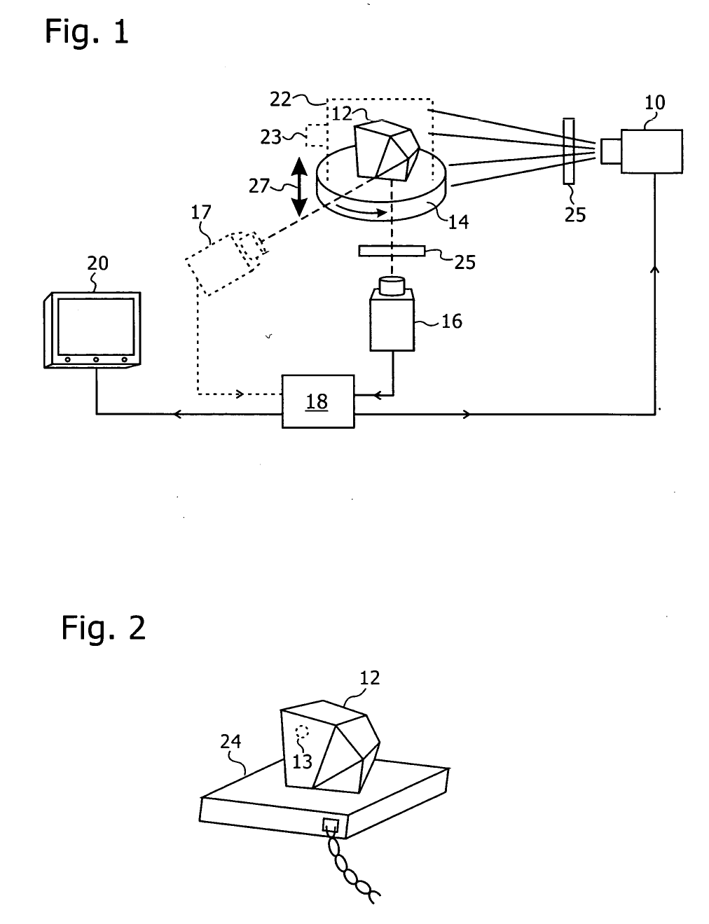

Reference is now made to FIG. 1, which schematically illustrates a system for the detection and mapping of inclusions in a diamond, constructed and operative according to a first preferred embodiment of the present invention. The system comprises a source 10, which preferably directs an infra-red beam of radiation towards the diamond 12 being investigated. However, the source 10 may alternatively and preferably be a visible source, or a UV source. The diamond is preferably mounted on an adjustable holder 14 which allows the diamond to be rotated in any direction desired. An infra-red imaging device, preferably an IR camera 16, is disposed at a position where it can view the diamond being irradiated, but does not directly see the infra-red radiation directed at the diamond from the infra-red source 10. A preferred location and pointing direction of the IR camera is thus perpendicular to the line joining the irradiation source with the diamond, and directed along a line intersecting the diamond. An optional second IR camera 17 is preferably provided, positioned at a known angle to the first 16, preferably 90 degrees, in order to generate a second set of images from which the three dimensional position of the inclusions can be calculated. Any of the conventionally used thermal IR bands can be used for viewing the stone, whether 3 to 5 microns, 7 to 13 microns, 8 to 14 microns, or any other suitable range for which cameras and optical components are available. The camera is preferably fitted with an objective lens designed to enable it to focus onto the stone at high magnification. However, since the depth of focus of a high magnification objective lens is comparatively short, it is generally only possible to image comparatively thin slices at a time, and a translation unit 27 is therefore generally required for moving the stone and its mounting relative to the camera lens, for imaging further slices through the depth of the stone. A thermally insulating enclosure 22 can be used in order to isolate the hot stone from its immediate environment, both to prevent it from cooling down too rapidly, and to protect it from extraneous IR interference to the imaging process. One or more thermo-electric cooling elements 23 can preferably be attached to the walls of the enclosure, to cool the enclosure walls down to below the ambient temperature, thereby substantially reducing background interference to the captured IR images. A glass or plastic tube, open in the direction of the heating source and the imaging camera, can be used as a simple and effective enclosure.

A filter unit 25 can preferably be used to limit the bandwidth, either of the incident heating radiation, or of the imaged beam, as described hereinabove, in order to provide wavelength discrimination from scattered or reflected incident light, to enable heating and imaging to be carried out simultaneously. Alternatively and preferably, polarized light could be used in order to provide better discrimination between the imaged light showing the imperfections and any scattered incident light. In this case, items 25 would alternatively, or even additionally, be polarizing and analyzing filters respectively on the input and output sides of the stone under inspection. Since some imperfections are related to strain in the stone, such strain may become detectable by viewing between crossed polarizers, as described in this preferred embodiment, such that the use of polarized light will also be operative to increase the detectability of imperfections. Alternatively and preferably, such polarizing elements can also be useful in the detection and characterization of imperfections which affect the polarization properties of light transmitted through them.

The image output from the camera 16 is input to a control unit 18, which preferably comprises a frame grabber and an image processing module. The output is preferably in the form of an infra-red image of the diamond, displayed on the monitor 20, with color grading of the temperature profile of the diamond, and optionally also a printout or digital record of the temperature profile of the diamond. Image processing programs can preferably be used in order to analyze the thermal map of the stone, to determine the positions of regions of increased temperature which can be identified as inclusions, and to then generate the position in three dimensions of the inclusions detected, and also to preferably provide a measure of their severity and/or character.

Reference is now made to FIG. 2, which is a schematic illustration of a further preferred part of the system for the detection and mapping of inclusions in a diamond 12, similar to that shown in FIG. 1 but in which the diamond under test is mounted on a hot plate 24, or an alternative conductive heat source, which is used to raise its temperature above that of the ambient instead of the lamp source in the embodiment of FIG. 1. In the diamond shown in FIG. 2, an inclusion 13 is shown inside the stone in one corner.

Alternatively and preferably, a hot air blower, could also be used to heat the stone by forced convection, or alternatively and preferably, the stone and its mounting could be located in an oven with suitable optical viewing ports.

Alternatively and preferably, in those embodiments where the diamond or other precious stone is cooled down below ambient temperature in order to perform the differential thermal imaging on it, then the plate 24 could preferably be a thermal cooling plate, such as a thermo-electric cooler, as a preferred method of cooling down the stone.

In any of the above-described preferred embodiments, it is generally sufficient to change the temperature of the stone by the order of 20 degrees above the ambient, or below the ambient when cooling embodiments are used, in order to generate the required image contrast effectively equivalent to a temperature differential of a few degrees to facilitate detection of the inclusions. For a stone of volume 1 cc., heated for a period of 10 seconds, a simple thermal capacity calculation shows that 4 watts of input power is sufficient for this task. Such a power level is easily obtained using simple and readily available means. It is to be understood however, that the invention is not limited to these preferred levels of heating, but can also preferably operate using heating to a higher temperature. According to further preferred embodiments, a quartz halogen lamp with a parabolic reflector is used to heat the stone to approximately 150° C. Using a preferred system of the present invention, such as one of the above-described embodiments, the detection and mapping of inclusions in a diamond can therefore be performed inexpensively, accurately and rapidly. This represents a significant advance over prior art methods of detecting such inclusions.

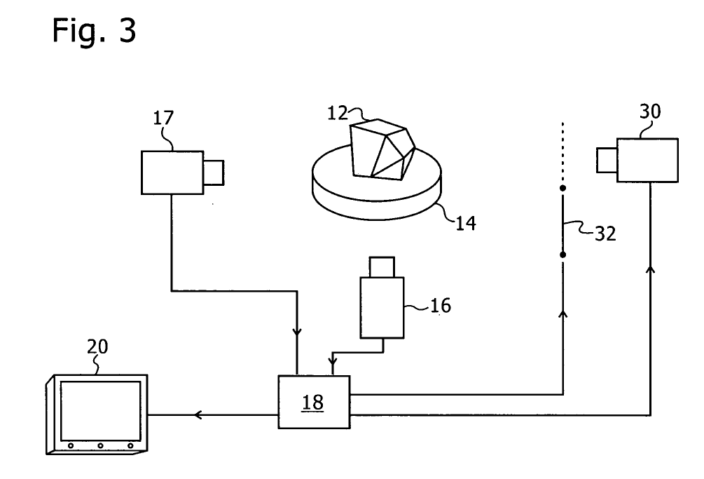

Reference is now made to FIG. 3, which is a schematic illustration of a further preferred system for the detection and mapping of inclusions in a stone such as a diamond, similar to that shown in FIG. 1 but in which use is made of the transient measurement technique described in the second embodiment hereinabove. In this configuration, the heat source 30 is preferably a radiation heat source, which is used to heat the stone 12, or more specifically, to preferentially heat the inclusions in the stone. Alternatively and preferably, the source can be a visible or UV source. Once the stone has been sufficiently heated, and at the point when the thermal images are to be obtained, the source 30 is preferably either switched off, or its light output is cut off by means of a shutter 32. This point in time is controlled by means of command signals from the control unit 18, and as soon as the radiation input has been cut off, a further command is preferably given to acquire IR images from one or both of the cameras 16, 17. The source may alternatively and preferably be a pulsed source for providing a single large input of energy to heat the stone, in which case, the shutter 32 is not needed, and the thermal imaging is performed immediately after the input energy pulse or pulses have been fired. According to any of these preferred embodiments, these images are then used, as previously described, for deriving a thermal map of the three dimensional position of any inclusions detected in the diamond.

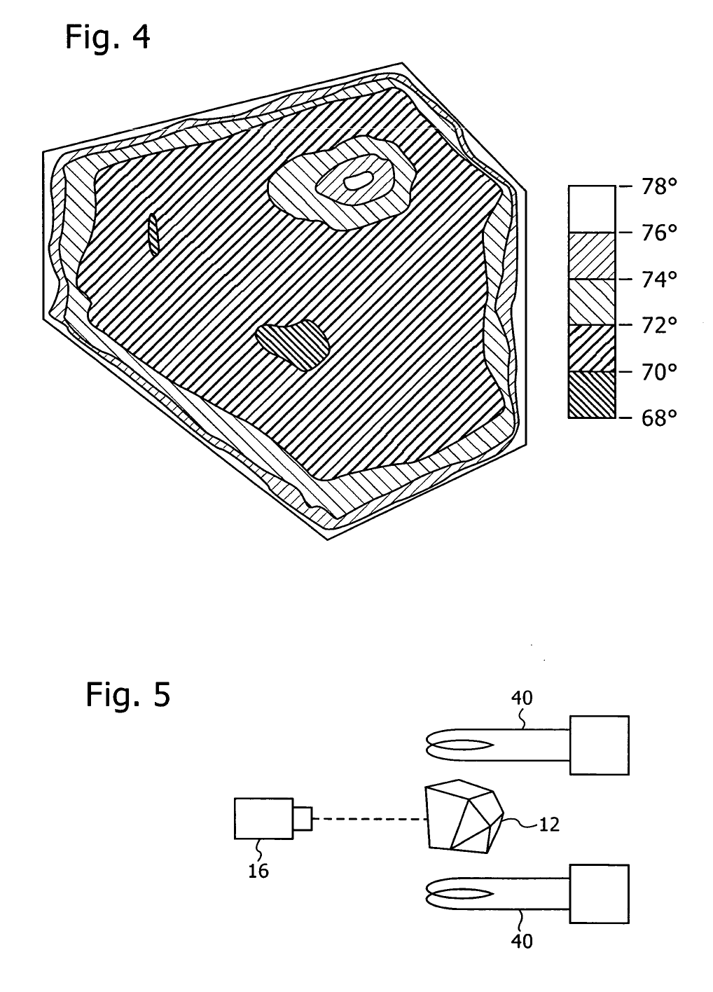

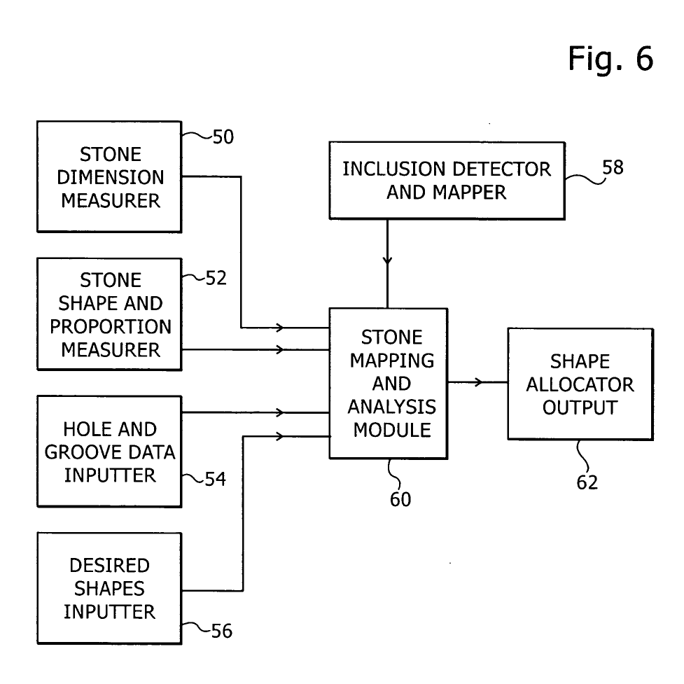

Reference is now made to FIG. 4, which is a schematic visualization of a thermal image of a heated diamond obtained using a system according to any of the above-described embodiments of the present invention. Though the different temperature ranges in the image of FIG. 4 are shown by different forms of shading, it is to be understood that in a real system, the different temperatures would be displayed on the image monitor by the image processing system, as different displayed colors. FIG. 4 shows a diamond being imaged during heating, and illustrating the presence of an inclusion in the diamond. The inclusion, at the top right hand side of the stone, is discerned in the image by its characteristic higher temperature than its immediate surroundings. The rest of the stone is generally colder. The lengthened dark region at the left side of the diamond is typical of an internal fault, which apparently scatters the radiation which would otherwise be imaged from that region, and therefore appears darker than its surroundings. Finally, the apparently higher temperature region around the periphery of the diamond is an artifact, due to reflection of the heating radiation from the stone faces. If the imaging is performed after the heating is terminated, these regions do not appear. However, according to another preferred embodiment of the present invention, this raised temperature outline can be utilized by the system in order to generate a plot of the outline of the stone, from whichever direction or directions the stone is being viewed. Such an outline plot can be of use in the embodiment shown in FIG. 6 below, where the overall shape of the stone is required as an input, in addition to the internal location of any imperfections.

Reference is now made to FIG. 5, which is a schematic illustration of a further preferred system for the detection and mapping of inclusions in a diamond, similar to that shown in FIG. 1 but in which use is made of an external source of energy to resonantly excite energy levels of the inclusions in the diamond, and to raise their temperature. In this embodiment, the excitation source or sources 40 can preferably be an electromagnetic field generator, whether in the optical, high frequency or RF region, or a phonon generator, such as an ultrasonic wave generator. The sources are shown as a pair of exciting coils in FIG. 5, though it is to be understood that this is just a schematic representation and that they are not meant to be limited thereto. The form of exciter used will be chosen according to the form of exciting energy used. The generator may preferably need to be close to the stone, in order to efficiently induce the exciting energy therein. The IR imaging scheme is preferably similar to that shown in FIG. 1, and only the camera 16 thereof is shown in this embodiment.

There exist in the art, computerized systems for the mapping and analysis of rough diamonds to enable the allocation of the stone to achieve the maximum yield possible from the stone. One such system is the DiaExpert system, supplied by Sarin Technologies Ltd., of Ramat Gan, Israel. However, such a prior art system bases its decisions on a geometric analysis of a three-dimensional spatial model of the shape of the rough stone, by optically measuring its dimensions and proportions, on the presence of internal flaws detectable by direct visual inspection, and on the different shape possibilities which the diamontaire is interested in obtaining. The three-dimensional spatial model is preferably obtained by one of the known methods of defining such a model, whether by determination of a set of co-ordinates defining the envelope of the stone, or by means of a set of three-dimensional polygonic shapes, or by use of a set of shapes defining planes in the stone and their vectorial directions relative to a known origin. These prior art systems thus take into account three of the four C's in allocating the shapes that can be produced from the rough diamond being analyzed, namely Cut, Color and Carat.

According to a further preferred embodiment of the present invention, information on the fourth C, namely the Clarity of the diamond, can be provided from the output information of any of the above described embodiments of the imperfection and inclusion detection and mapping systems of the present invention, and can then be input to a prior art computerized system for the mapping and analysis of rough diamonds, thus completing the decision making inputs which the system can use in its allocating process.

Reference is now made to FIG. 6, which is a schematic block diagram of a total solution, rough diamond computerized analyzing system, constructed and operative according to a further preferred embodiment of the present invention. The system of FIG. 6 includes the prior art inputs performed by optical measurement, of overall dimension measurement 50, overall shape and proportion measurement 52, the position of any holes or grooves observed visually in the rough stone 54, and an input 56 relating to the desired shapes desired from the stone. According to this preferred embodiment of the present invention, an additional input in the form of a computerized inclusion map 58, generated by one of the preferred stone inspection systems of the previously described embodiments of the present invention, is also provided to the stone mapping and analysis module 60, such that the allocation output generator 62 is also able to take into account the presence, severity and position of such inclusions before making its decisions and allocation recommendations. This system is thus able to take into account a more complete set of parameters about the rough stone, acquired by computerized measurement techniques, and to thus provide a more complete solution than previously available for cutting the stone.

According to a further preferred embodiment of the present invention, one of the geometrical parameters of the rough stone, namely the shape of the envelope in three dimensions, can be obtained from the computerized stone imperfection detection system of the present invention, as described hereinabove, and the envelope shape used as one of the inputs to the rough diamond computerized analyzing system of this embodiment of the present invention.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A system for the inspection of a precious stone, comprising:
an energy transfer system for changing the temperature of said stone;
at least one imaging device imaging said stone and outputting a thermal map of said stone;
an image processing unit utilizing said thermal map to determine regions having changed emission in said thermal map; and
an analyzing unit detecting at least one imperfection in said stone from said regions of changed emission.

2. A system according to claim 1 and wherein said detecting comprises determining at least one of the location, character and size of said at least one imperfection.

3. A system according to claim 1 and wherein said energy transfer system comprises an energy source such that said changing the temperature of said stone comprises raising the temperature of said stone above that of its environment.

4. A system according to claim 1 and wherein said energy transfer system comprises an energy sink such that said changing the temperature of said stone comprises lowering the temperature of said stone below that of its environment.

5. A system according to claim 1 and wherein said at least one imaging device images said stone in the infra red region.

6. A system according to claim 1 and wherein said at least one imaging device is a camera.

7. A system according to claim 1 and wherein said regions of changed emission result from a change in temperature at said location from the temperature in the remainder of said stone.

8. A system according to claim 1 and wherein the characteristics of said at least one imperfection in said stone is determined from the level of said changed emission.

9. A system according to claim 7 and wherein the characteristics of said at least one imperfection in said stone is determined from the level of said changed temperature.

10. A system according to claim 1, and wherein said at least one imaging device is two imaging devices, such that said location of said at least one imperfection in said stone is determined in three dimensions.

11. A system according to claim 1, and wherein said stone is angularly aligned relative to said imaging device for imaging in at least two directions, such that said location of said at least one imperfection in said stone is determined in three dimensions.

12. A system according to claim 11, and wherein said stone is angularly realigned relative to said imaging device by means of a turntable on which said stone is mounted.

13. A system according to claim 3, and wherein said energy source for raising the temperature of said stone is at least one of a radiation source, a hot air source, and a conduction source.

14. A system according to claim 13 and wherein said radiation source emits at least one of infra red, visible or ultra violet energy.

15. A system according to claim 13 and wherein said conduction source is a hot plate.

16. A system according to claim 14 and also comprising a filter disposed between said source and said stone, such that said stone is irradiated with energy having a more limited wavelength bandwidth than the imaging bandwidth.

17. A system according to claim 14 and also comprising a filter disposed between said stone and said imaging device, such that said stone is imaged at a wavelength bandwidth more limited than that of said radiation.

18. A system according to claim 16 and wherein said filter is operative to reduce the effect of reflections or scattering of said energy from said radiation source on said images of said stone.

19. A system according to claim 17 and wherein said filter is operative to reduce the effect of reflections or scattering of said energy from said radiation source on said images of said stone.

20. A system according to claim 4, and wherein said energy sink for lowering the temperature of said stone is a thermoelectric cooling device.

21. A system according to claim 1 and also comprising at least a pair of polarizing elements, at least one element being located between said energy source and said stone, and at least another element being located between said stone and said imaging device.

22. A system according to claim 1 and wherein said stone is a diamond.

23. A system according to claim 1 and wherein said imperfection is an inclusion.

24. A system according to claim 1 and wherein said imperfection is an internal structural flaw.

25. A system according to claim 1 and wherein said imaging device generates successive images of said stone at different temperatures and at a fixed wavelength, and determines the characteristics of a detected imperfection by comparison with predetermined information relating to the emissive properties of imperfections as a function of temperature.

26. A system according to claim 1 and wherein said imaging device generates successive images of said stone at different wavelengths and at a fixed temperature, and determines the characteristics of a detected imperfection by comparison with predetermined information relating to the emissive properties of imperfections as a function of wavelength.

27. A method for the inspection of a precious stone, comprising the steps of:
changing the temperature of said stone by means of an energy transfer system;
imaging said stone by means of at least one imaging device;
outputting a thermal map of said stone from said at least one imaging device;
image processing said thermal map to determine regions of changed emission in said thermal map; and
analyzing said regions of changed emission for detecting at least one imperfection in said stone.

28. A method according to claim 27 and wherein said detecting comprises determining at least one of the location, character and size of said at least one imperfection.

29. The method of claim 27 and wherein said energy transfer system comprises an energy source such that said step of changing the temperature of said stone comprises the step of raising the temperature of said stone above that of its environment.

30. The method of claim 27 and wherein said energy transfer system comprises an energy sink such that said step of changing the temperature of said stone comprises the step of lowering the temperature of said stone below that of its environment.

31. The method of claim 27 and wherein said at least one imaging device images said stone in the infra red region.

32. The method of claim 27 and wherein said at least one imaging device is a camera.

33. The method of claim 27 and wherein said regions of changed emission result from a change in temperature at said location from the temperature in the remainder of said stone.

34. The method of claim 29 and wherein said imaging step is performed after terminating said step of raising the temperature of said stone above that of its environment by means of said energy source.

35. The method of claim 34 and wherein said step of terminating said raising the temperature of said stone is performed by means of a shutter.

36. The method of claim 34 and wherein said energy transfer to said stone is by means of at least one pulse of energy.

37. The method of claim 27 and wherein said imaging step is performed while said step of changing the temperature of said stone by means of an energy transfer system is continued.

38. The method of claim 27, and wherein said step of imaging said stone by means of at least one imaging device is performed by means of two imaging devices, such that said location of said at least one imperfection in said stone is determined in three dimensions.

39. The method of claim 27, and also comprising the step of angularly aligning said stone relative to said imaging device in at least two directions for performing said imaging, such that said location of said at least one imperfection in said stone is determined in three dimensions.

40. The method of claim 39, and wherein said step of angularly aligning said stone comprises the steps of:
providing a turntable for mounting said stone thereupon; and
rotating said turntable with said stone mounted thereon to image said stone in at least two directions, such that said location of said at least one imperfection in said stone is determined in three dimensions.

41. The method of claim 29, and wherein said energy source is at least one of a radiation source, a hot air source, and a conduction source.

42. The method of claim 41, and wherein said conduction source is a hot plate.

43. The method of claim 41, and wherein said radiation source emits at least one of infra red, visible or ultra violet energy.

44. The method of claim 43, and also comprising the step of disposing a filter between said radiation source and said stone, such that said stone is irradiated with energy having a more limited wavelength bandwidth than the imaging bandwidth.

45. The method of claim 43, and also comprising the step of disposing a filter between said stone and said imaging device, such that said stone is imaged at a wavelength bandwidth more limited than that of said radiation.

46. The method of claim 44, and wherein said filter is operative to reduce the effect of reflections or scattering of said energy from said radiation source on said images of said stone.

47. The method of claim 30, and wherein said energy sink for the step of lowering the temperature of said stone below that of its environment is a thermoelectric cooling device.

48. The method according to claim 27 and wherein said stone is a diamond.

49. The method according to claim 27 and wherein said imperfection is an inclusion.

50. The method according to claim 27 and wherein said imperfection is an internal structural flaw.

51. A computerized optical system for the analysis of precious stones, comprising a stone mapping module inputting information to an output shape allocator, said stone mapping module taking its inputs from:
a three dimensional spatial model of said stone;
an input module defining a desired shape of at least one cut to be obtained from said precious stone; and
output information from a computerized imperfection detection unit.

52. A computerized optical system for the analysis of precious stones, according to claim 51, wherein said three dimensional spatial model of said stone comprises at least one of:
a set of co-ordinates defining the envelope of said stone;
a set of three-dimensional polygonic shapes; and
a set of shapes defining planes in said stone, and their vectorial directions relative to a known origin.

53. A computerized optical system for the analysis of precious stones, according to claim 51, wherein said three dimensional spatial model of said stone is obtained from at least one of:
a stone dimension measuring unit;
a stone shape measuring unit;
a hole data input unit; and
groove data input unit.

54. A computerized optical system for the analysis of precious stones, according to claim 51, and wherein said computerized imperfection detection unit also provides outline data of said stone for said three dimensional spatial model of said stone.

55. A computerized optical system for the analysis of precious stones, according to claim 51, and wherein said computerized imperfection detection unit is a thermal imaging imperfection detection system.
